(19) United States
(12) Patent Application Publication
(10) Pub. No.: US 2009/0325820 A1
(43) Pub. Date: Dec. 31, 2009

(54) Hardware acceleration for thermodynamically constrained DNA code generation

(76) Inventors: Daniel J. Burns, Rome, NY (US); Qinru Qiu, Vestal, NY (US); Qing Wu, Vestal, NY (US); Prakash Mukre, Newport Beach, CA (US); Morgan A. Bishop, Rome, NY (US)

Correspondence Address: AIR FORCE RESEARCH LABORATORY RIJ, 26 ELECTRONIC PARKWAY, ROME, NY, 13441-4514, US

(21) Appl. No.: 12/455,564

(22) Filed: Jun. 3, 2009

Related U.S. Application Data
(60) Provisional application No. 61/132,338, filed on Jun. 5, 2008.

(51) Int. Cl. C40B 40/08; C40B 60/14

(52) U.S. Cl. 506/17; 506/40

(57) ABSTRACT

An apparatus that accelerates the determination of NN free energy of binding estimates for a large number of DNA oligomers using reconfigurable hardware and applies it to the design of high quality DNA code word libraries. The invention provides a reconfigurable hardware accelerator and method for implementing a nearest-neighbor based free energy calculation. The invention further provides a method to produce the maximum weight of the 2-stem common subsequence of two DNA oligonucleotides. In practice, the present invention comprises a general purpose microprocessor or computer, a hardware accelerator, and a software program.

### PRIORITY CLAIM UNDER 35 U.S.C. §119(e)

This patent application claims the priority benefit of the filing date of a provisional application Ser. No. 61/132,338, filed in the United States Patent and Trademark Office on Jun. 5, 2008.

### STATEMENT OF GOVERNMENT INTEREST

The invention described herein may be manufactured and used by or for the Government of the United States for governmental purposes without the payment of any royalty thereon.

### BACKGROUND OF THE INVENTION

A single DNA strand (i.e. oligonucleotide) is a molecule made up of two polymers forming a sequence of complimentary pairs of nucleobases, each of which typically is one of four possible nucleotides denoted as A, C, G and T. Short DNA sequences can be synthesized easily and have been proposed for use in different applications in information processing, including high density information storage [2], molecular computation of hard combinatorial problems [1], and molecular barcodes to identify individual modules in complex chemical libraries [3]. These applications rely on the specific hybridization properties of the half-strands that result when a specially chosen set of DNA strands is denatured and allowed to re-bind. A single short strand of DNA is referred to as a ‘code word pair’, each being made up of two half-strands, a ‘code word’ and its Watson Crick complement. The key to success in all of these DNA information processing applications is the availability of a large set, or library of DNA code word pairs whose half-strands crosshybridize perfectly within each code-word pair, but poorly with the half-strands from all other code word pairs in the set, according to some hybridization metric. Thus, if all the code word pairs in the library are heated and denatured in the same compartment and then cooled and allowed to hybridize, only the original code words hybridize and are recovered. This effect can be used to obtain spatial addressability of the binding location of different DNA half-strands in a second set of DNA strands, if each type of half-strand in the second set is ligated to a different half-strand in the code word library, and if the mixture is allowed to bind onto a substrate that is treated with different localized areas each treated, or containing, or functionalized with, a different corresponding half-strand of the library set. Alternatively, a string of many half-strand code words can be constructed, and each half-strand code word either hybridized with its complement or not, thereby representing 1's or 0's, and encoding digital data onto the constructed strand.

The capability of hybridization between two oligonucleotides is determined by the base sequences of the hybridizing oligonucleotides, the location of potential mismatches, the molar concentrations of the strands, the temperature of the reaction, the salinity of the medium, and the length of the sequences [4]. The melting temperature (Tₘ) is a parameter that characterizes these factors [4]. It is defined as the temperature at which 50% of the DNA molecules have been separated to single strands, or denatured. Another closely related measure of the relative stability of a DNA duplex is its Gibbs free energy denoted as ΔG^{O}. The nearest-neighbor (NN) model [8] was proven to be an effective and accurate estimation of the free energy. In [14], the concept of t-stem block insertion-deletion codes was introduced that captures the key aspects of the nearest neighbor model. In the same reference, a dynamic programming algorithm is presented to calculate the maximum weight of the t-stem common subsequence.

Search methods for DNA codes are extremely time-consuming [5], and this has limited research on DNA codeword design, especially for codes of length greater than about 12-14 bases. For example, the largest known DNA codeword library generated based on the edit distance constraints (an easier to determine metric than pair-wise nearest neighbor model) with length 16 and edit distance 10 consists of 132 pairs, and composing such codes can take several days on a cluster of processors.

Commonly assigned U.S. patent application Ser. No. 12/378,261, disclosed a novel accelerator for the composition of reverse complement, edit distance DNA codes of length 16. The invention disclosed in Ser. No. 12/378,261 incorporates a hardware genetic algorithm (GA), hardware edit distance calculation, and hardware exhaustive search, the latter of which extends an initial codeword library by doing a final scan across the entire universe of possible code words. An embodiment of the invention disclosed in Ser. No. 12/378,261 comprises a host PC, a hardware accelerator implemented in reconfigurable logic on a field programmable gate array (FPGA) and a software program running in a host PC that controls and communicates with the hardware accelerator. The embodiment uses a modified genetic algorithm (GA) that uses a locally exhaustive, mutation-only heuristic tuned for speed, and optional selection, mating, and decloning steps. The embodiment successfully reduced the DNA codeword library construction time from 6 days (on 10 Pentium processors) to 1.5 hours (on a notebook computer with FPGA card) and achieved an effective 1000× speed-up.

The edit distance metric only provides a first order approximation of the free energy of the DNA duplexes. To improve the quality of the code words, a more accurate method based on the thermodynamics of DNA duplex binding is needed.

The DNA molecule is a nucleic acid. It consists of two oriented oligonucleotide sequences. One end of it is denoted as 3′ and the other as 5′. There are four types of bases, denoted briefly as A, T, C, and G. Each base can pair up with only one particular base through hydrogen bonds: A+T, T+A, C+G and G+C. It is common to say that A and T are complementary to each other while C and G are complementary to each other. A Watson-Crick complement of a DNA sequence is another DNA sequence which replaces all the A with T or vise versa and replaces all the T with A or vise versa, and also switches the 5′ and 3′ ends. Referring to FIG. 1A a DNA sequence binds most stably with its Watson-Crick complement and the structure they form is called Watson-Crick (WC) duplex. Referring to FIG. 1B, a non-WC duplex is referred to as a crosshybridized (CH) duplex. Only WC duplexes are needed during DNA computing. Therefore, it is important to design the DNA codes such that a fixed temperature can be found that is well above the melting point of all CH duplexes and well below the melting point of all WC duplexes that can form from any two half-strands in the code.

The thermodynamics of binding of nucleic acids has been widely studied and reported in the literature. The nearest-neighbor (NN) model [8] was proven to be effective and accurate for the thermodynamic energy estimation. The NN model assumes that stability of a DNA duplex depends on the identity and orientation of neighboring base pairs. There are 10 possible NN pairs: AA/TT, AT/TA, TA/AT, CA/GT, GT/CA, CT/GA, GA/CT, CG/GC, GC/CG, and GG/CC. Based on the NN model, the total free energy change of a DNA duplex at temperature T can be calculated by the following equation:

$$Δ {G}_{T}^{o} ( total ) = Δ {G}_{T , initiation}^{o} + Δ {G}_{T , symmetry}^{o} + {\sum }_{i ∈ Watson - Crick NNS} {G}_{T , stack}^{o} ( i ) + Δ {G}_{T , AT Terminal}^{o} ,$$

where ΔG^{O}_{T,initiation} is the initiation energy, ΔG^{O}_{T,symmetry} is a parameter that reflects whether the duplex is self-complementary, ΔG^{O}_{T,AT Terminal} is a parameter that accounts for the differences between duplexes with terminal AT versus terminal GC, ΔG^{O}_{T,stack(i)} gives the thermodynamic energy of Watson-Crick NN duplex i. Their values at 37° C. are given in FIG. 2.
Example: Using the values depicted in FIG. 2, the NN free energy of DNA duplex

5′-CGTTGA-3′
3′-GCAACT-5′

can be calculated as:

Σ_{iεWC NN}_{ₛ}ΔG^{O}_{T,stack}(i)=ΔG_{37,stack}(CG)+ΔG_{37,stack}(GT)+ΔG_{37,stack}(TT)+ΔG_{37,stack}(TG)+ΔG_{37,stack}(GA)=−2.17−1.44−1.00−1.45−1.3=−5.35 kcal mol⁻¹.

While the parameters ΔG^{O}_{T,initiation}, ΔG^{O}_{T,symmetry}, and ΔG^{O}_{T,AT Terminal} can be obtained in a straightforward manner, the NN free energy (i.e. Σ_{iεWC NN}ΔG^{O}_{T,stack}(i)) is determined by the structure of the primary sequence of the DNA duplex.

### OBJECTS AND SUMMARY OF THE INVENTION

The present invention provides an apparatus that accelerates the determination of NN free energy using reconfigurable hardware and applies it to hardware based DNA code word search.

Specifically, the present invention provides an apparatus that determines the maximum weight of the 2-stem common subsequence of two DNA oligonucleotides.

The present invention provides an apparatus for determining the maximum weight of the 2-stem common subsequence of two DNA olgiconucleotides which in turn the present invention uses to determine an estimate of the nearest neighbor Gibb's free energy of binding between DNA olgiconucleotides.

The apparatus of the present invention provides a computer, hardware accelerator, and a software program for the production of high quality DNA codeword libraries constructed with hybridization constraints based on nearest neighbor method estimates of the Gibb's free energy of binding between DNA olgiconucleotides.

### REFERENCES

[1] L. M. Adleman, “Molecular Computation of Solutions to Combinatorial Problems,” Science, vol. 266, pp. 1021-1024, November 1994.
[2] M. Mansuripur, P. K. Khulbe, S. M. Kuebler, J. W. Perry, M. S. Giridhar, and N. Peyghambarian, “Information Storage and Retrieval using Macromolecules as Storage Media,” Proceedings of Optical Data Storage, 2003.
[3] S. Brenner and R. A. Lerner, “Encoded Combinatorial Chemistry,” Proc. Natl. Acad. Sci. USA, vol 89, pp 5381-5383, June 1992.
[4] R. Deaton and M. Garzon, “Thermodynamic Constraints on DNA-based Computing,” Computing with Bio-Molecules: Theory and Experiments, Springer-Verlag.
[5] A. Brenneman and A. Condon, “Strand Design for Biomolecular Computation”, Theoretical Computer Science, vol. 287, pp. 39-58, 2002.
[6] S.-Y. Shin, I.-H. Lee, D. Kim, and B.-T. Zhang, “Multiobjective Evolutionary Optimization of DNA Sequences for Reliable DNA Computing”, IEEE Transactions on Evolutionary Computation, vol. 9(20), pp. 143-158, 2005.
[7] F. Tanaka, A. Kameda, M. Yamamoto, and A. Ohuchi, “Design of Nucleic Acid Sequences for DNA Computing based on a Thermodynamic Approach,” Nucleic Acids Research, 33(3), pp. 903-911, 2005.
[8] J. Santalucia, “A Unified View of polymer, dumbbell, and oligonucleotide DNA nearest neighbor thermodynamics”, Proc. Natl. Acad. Sci., Biochemistry, pp. 1460-1465, February 1998.
[9] Qinru Qiu, D. Burns, Q. Wu and Prakash Mukre, “Hybrid Architecture for Accelerating DNA Codeword Library Searching,”Proc. IEEE Symposium on Computational Intelligence in Bioinformatics and Computational Biology, April 2007.
[10] http)://www.annapmicro.com/
[11] D. Burns, K. May, T. Renz, and V. Ross, “Spiraling in on Speed-Ups of Genetic Algorithm Solvers for Coupled Non-Linear ODE System Parameterization and DNA Code Word Library Synthesis,” MAPLD International Conference, 2005.
[12] J. SantaLucia, Jr. and D. Hicks, “The thermodynamics of DNA Structural Motifs,” Annu. Rev. Biophys. Biomol. Struct. 33:415-40, 2004.
[13] M. A. Bishop, A. J. Maculal, T. E. Renz, “SynDCode: Cooperative DNA Code Generating Tool,” Proc. of 3^{rd} Annual Conference of Foundations of Nanoscience, April, 2006.
[14] A. G. D'yachkov, A. J. Macula, W. K. Pogozelski, T. E. Renz, V. V. Rykov, and D. C. Torney, “A Weighted Insertion-Deletion Stacked Pair Thermodynamic Metric for DNA Codes,” Lecture Notes in Computer Science, Vol. 3384/2005, pp. 90-103, Springer Berlin/Heidelber.

### BRIEF DESCRIPTION OF THE DRAWINGS

FIG. 1a depicts a Watson-Crick duplex.

FIG. 1b depicts a non-Watson-Crick or crosshybridized (CH) duplex.

FIG. 2 depicts the thermodynamic energy of a Watson-Crick NN duplex i, at 37° C.

FIG. 3a depicts the secondary structures in the CH duplex for σ_{τ}²=2, 3, 8.

FIG. 3b depicts the secondary structures in the CH duplex for σ_{τ}²=2, 3, 7.

FIG. 4a depicts the structure of each systolic array cell, including its input/output and the computation implemented.

FIG. 4b depicts the overall architecture of a 2D systolic array as well as the data dependency and timing information.

FIG. 5 depicts the average time it takes to build a large thermodynamic constrained DNA code word library using software on a single processor workstation versus using a hardware accelerator.

FIG. 6a depicts library size versus time for search time under different crosshybridized duplex (CH) ranges.

FIG. 6b depicts the number of codeword pairs found in 200 seconds.

FIG. 6c depicts the time to find 400 codeword pairs under different CH ranges.

FIG. 7a depicts the runtime of a GA under different ranges.

FIG. 7b depicts the size of the codeword library found by a GA and the size of the final library.

FIG. 8a depicts the number of codeword pairs found in five (5) minutes for CH upper bounds ranging from 5 to 8.0.

FIG. 8b depicts the runtime to find 300 codeword pairs for CH upper bounds ranging from 8.5 to 10.

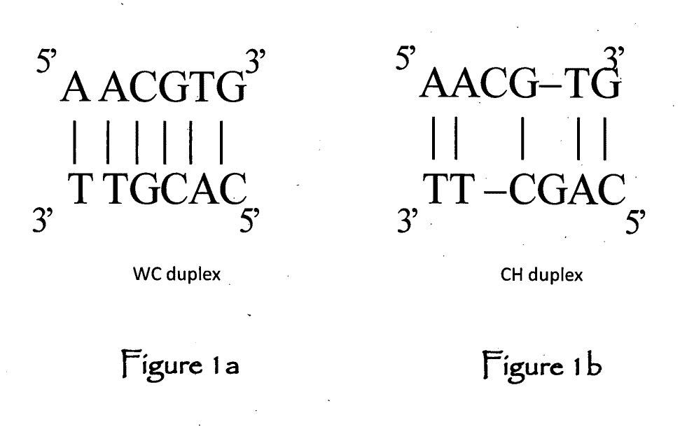

### DETAILED DESCRIPTION OF THE GENERALIZED EMBODIMENT

The present invention provides a hardware accelerator and method for implementing a nearest-neighbor based free energy calculation. The invention further provides a method to produce the maximum weight of the 2-stem common subsequence of two DNA oligonucleotides. In practice, the present invention would comprise a general purpose microprocessor or computer, a hardware accelerator, and a software program. One skilled in the art would appreciate that the hardware accelerator could be implemented as a reconfigurable Field Programmable Gate Array (FPGA), or an Application Specific Integrated Circuit (ASIC), or an embedded processor, or a Cell BroadBand Engine processor, or a Graphical Processing Unit, but by no means is limited to such implementations.

The determination of the Gibbs free energy of the DNA crosshybridized (CH) duplexes based on the nearest-neighbor model is key to the present invention. The invention's transformed algorithm preserves the physical data locality and hence is suitable to be implemented using systolic array. The invention provides a novel hardware accelerator for accelerating the discovery of DNA which binds according to thermodynamic constraints and which provides more than 250× speed-up compared to a software only implementation.

### T-Stem Block Insertion-Deletion Codes

The description of the present invention herein adopts notations that are likewise used in references [1] and [14]. We use [n] to denote the set {0, . . . , n−1 } and (n) to denote the sequence 1, 2, . . . , n. We call α<(n) a string if and only if it is a subsequence of consecutive integers, e.g., α=i, i+1, . . . , i+k. Let [q]ⁿ denote the set of sequences of length n with entries in [q]. For x=x₁, . . . , xₙ with xε[q]ⁿ and σ=i₁, i₂, . . . , iₖ where σ<(n), we use x_{σ}<x to denote the subsequence xᵢ_{₁}, xᵢ_{₂}, . . . , xᵢ_{ₖ} and x [i] to denote the ith entry in sequence x. Given a non-negative real-valued function, Ω, on [q], we define the weight of subsequence x_{σ} as

$${‖ {x}_{σ} ‖}_{Ω} = {\sum }_{i ∈ σ} Ω ( {x}_{i} ) .$$

For σ<(n), a substring β<σ is called a block of σ if β is not a subsequence of any substring α of σ with β≠α. Denote σ as a sequence of blocks β₁, β₂, . . . , βᵢ, . . . , βₗ, if the difference between the endpoint of βᵢ and the starting point of βᵢ₊₁ is greater than or equal to t, then σ is a t-gap sequence of (n). It is denoted as σεGₜ(n). Given σ<(n), τ<(m) with |σ|=|τ| and σεGₜ(n), τεGₜ(m), let f: σ→τ be a unique mapping, σ and τ are said to be t-gap block isomorphic (denoted as

$$σ {≅}_{t} τ )$$

if α<σ is string [symbol] f(α)<τ is a string. For xε[q]ⁿ and yε[q]^{m}, if x_{σ}=y_{τ} and

$$σ {≅}_{t} τ ,$$

then we say x_{σ} and y_{τ} are t-gap block isomorphic and denote it as

$${x}_{σ} {≅}_{t} {y}_{τ} .$$

Definition 1 For 2≦t≦n−1 and x, y ε[q]ⁿ, we define the weight of the longest common t-gap block subsequence of x and y as

$${φ}_{Ω , q}^{t} ( x , y ) ≡ max \{ {‖ {x}_{σ} ‖}_{Ω} : {x}_{σ} {≅}_{t} {y}_{τ} \} .$$

The weighted distance of two t-gap block insertion-deletion codes is defined as Φ_{Ω,q}^{t}(x,y)≡min(∥x∥_{Ω},∥y∥_{Ω})−φ_{Ω}^{t}(x,y). When t=1 and ∥x_{σ}∥_{Ω}=|x_{σ}|, Φ_{Ω,q}¹(x,y) is the Levenshtein insertion-deletion distance.

The weight of the longest common t-gap block subsequence of x and y (i.e. φ_{Ω}^{t}(x,y)) can be calculated using dynamic programming. For x, y ε[q]ⁿ and t≦i, j≦n, let M_{Ω,i,j}^{t} denote φ_{Ω}^{t}(x_{[1,i]}, y_{[1,j]}) and suf (x,y) denote the length of the longest common suffix between x and y. It is proved ([1][14]) that:

M_{Ω,i,j}^{t}=max(M_{Ω,i-1,j}^{t},M_{Ω,i,j-1}^{t},D_{Ω,i,j}^{t}}, (1)

where D_{Ω,i,j}^{t} is defined as

$${D}_{Ω , i , j}^{t} = \{ \begin{matrix}max \{ \begin{matrix}{‖ {x}_{[ i - r + 1 , i ]} ‖}_{Ω} + \\ {M}_{Ω , i - r - t + 1 , j - r - t + 1}^{t} : \\ 1 \leq r \leq suf ( {x}_{[ 1 , i ]} , {y}_{[ 1 , j ]} )\end{matrix} \} & if suf ( {x}_{[ 1 , i ]} , {y}_{[ 1 , j ]} ) \geq 1 \\ 0 & otherwise .\end{matrix} \qquad ( 2 )$$

Given two sequences x, yε[q]ⁿ, x_{σ}=y_{τ} with a unique mapping f: σ→, a t-stem exists if and only if subsequences x_{[i,i+t-1]}=y_{[f(i),f(i)+t-1]}. Let σ_{τ}^{t} be the sequence of the first index of all the t-stems. For xε[q]ⁿ, let d_{q}(x_{[α,α+t-1]}) be a unique number in [q^{t}] to represent x_{α}x_{α+1} . . . x_{α+t-1}, we define x^{(t)}ε[q^{t}]^{n-t} as a sequence whose ith element is equal to (d_{q}(x_{i,i+t-1]}). For 2≦t≦n−1, it can be proved that if |σ_{τ}^{t}|≠0, then

$${x}_{{σ}_{τ}^{t}}^{( t )} {≅}_{t} {y}_{f ( {σ}_{τ}^{t} )}^{( t )} .$$

Definition 2 Let Ω be a weight function on [q^{t}], the maximum weighted t-stem common subsequence is defined as

$${ψ}_{Ω}^{t} ( x , y ) = max \{ ‖ {x}_{{σ}_{τ}^{t}}^{( t )} ‖ \} .$$

The t-stem code distance is defined as Ψ^{t}(x,y)=min(∥x^{(t)}∥_{Ω},∥y^{(t)}∥Ω)−ψ_{Ω}^{t}(x,y).

It is proved ([1][14]) that the maximum weighted t-stem common subsequence of x and y is equal to the weight of the longest common t-gap block subsequence of x^{(t)} and y^{(t)}, i.e. ψ_{Ω}^{t}(x,y)=φ_{Ω,q}_{^{t}}^{t}(x^{(t)},y^{(t)}).

Let the CH duplex between x and y̅ be denoted as

$$x : \overleftarrow{\overline{y}} ,$$

where y̅ is the WC complement of y and

$$\overleftarrow{\overline{y}}$$

is a representation of y̅ in reversed order. If the duplex

$$x : \overleftarrow{\overline{y}}$$

have a secondary structure, then its free energy of nearest neighbor stacked pairs can be calculated as ψ_{Ω}²(x,y), where the weight function Ω is equal to −ΔG^{O}_{T,stack}.
Example: Consider the CH duplex

5′-AACGTAGAT-3′
3′-GCTGCTACT-5′.

It corresponds to strings x=AACGTAGAT and y=CGACGATGA. Because x_{[2,4][8,9]}=y_{[3,5][6,7]}, we have σ=[2, 4][8, 9], τ=[3, 5][6, 7], σ_{τ}²=2, 3, 8, and ∥x_{σ}⁽²⁾=∥x_{2,3,8}⁽²⁾=−ΔG_{37,stack}(AC)−ΔG_{37,stack}(CG)−ΔG_{37,stack}(AT)=4.49 kcal/mol.

Let A, C, G, T be encoded as 0, 1, 2, and 3, then x=0, 0, 1, 2, 3, 0, 2, 0, 3 and y=1, 2, 0, 1, 2, 0, 3, 2, 0. x⁽²⁾=0, 1, 6, 11, 12, 2, 8, 3 and y⁽²⁾=6, 8, 1, 6, 8, 3, 14, 8. It is easy to see that x_{2,3,8}⁽²⁾=y_{3,4,6}⁽²⁾. Let σ=2, 3, 8 and τ=3, 4, 6, because any string in C corresponds to a string in τ, and the gaps between blocks in σ and τ are equal to 2, we say

$$σ {≅}_{2} τ and {x}_{σ}^{( 2 )} {≅}_{2} {y}_{τ}^{( 2 )} .$$

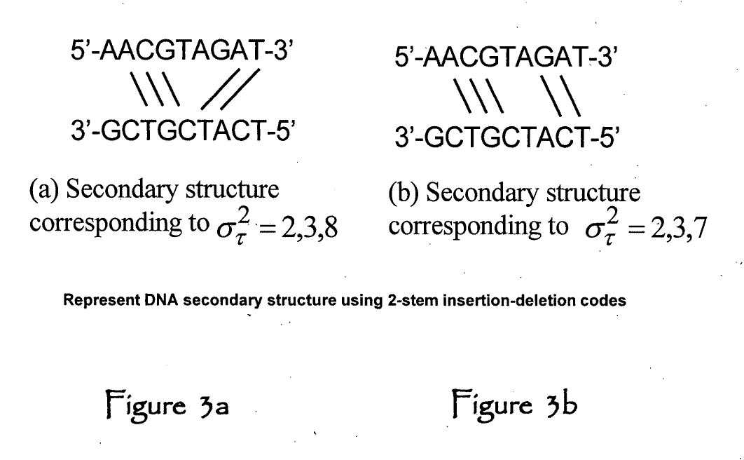

Note that although x_{2,3,7,8}⁽²⁾=y_{3,4,5,6}⁽²⁾, because a string in τ=3, 4, 5, 6 does not necessarily correspond to a string in σ=2, 3, 7, 8, therefore, x_{2,3,7,8}⁽²⁾ and y_{3,4,5,6}⁽²⁾ are not t-gap block isomorphic. Using equation (1) and (2) we can find that ψ_{Ω}²(x,y)=φ_{Ω}^{t}(x⁽²⁾,y⁽²⁾)=∥x_{2,3,7}⁽²⁾∥=−ΔG_{37,stack}(AC)−ΔG_{37,stack}(CG)−ΔG_{37,stack}(GA)=4.91 kcal/mol. Referring to FIG. 3a shows the secondary structures in the CH duplex for σ_{τ}²=2, 3, 8 Referring to FIG. 3b shows the secondary structures in the CH duplex that for 3b σ_{τ}²=2, 3, 7. In the present invention, the NN free energy of a CH duplex is estimated by calculating their maximum weighted 2-stem common subsequence.

### Calculation of NN Free Energy Using 2D Systolic Array

The present invention provides an apparatus for executing a dynamic programming algorithm within a 2D systolic array implementation. The invention employs software implementable steps to determine the conditions defined by equations (1) and (2). Given a CH duplex

$$x : \overleftarrow{\overline{y}} ,$$

we define 3 matrices. They include a suffix matrix (S) which stores the length of the longest common suffix between x and y, a weighted suffix matrix (WS) which stores the accumulated weight of each common stem-2 and an energy matrix (E) which stores the accumulated free energy of the possible NNs. The value of the ijth entry of these matrices can be determined using the following equations.

$$\begin{matrix}{s}_{ij} = \{ \begin{matrix}{s}_{i - 1 , j - 1} + 1 & if x [ i ] = y [ j ] \\ 0 & otherwise ,\end{matrix} & ( 3 ) \\ {ws}_{i , j} = \{ \begin{matrix}{ws}_{i - 1 , j - 1} + w ( x [ i - 1 ] , x [ i ] ) & \begin{matrix}if x [ i ] = y [ j ] \& \\ x [ i - 1 ] = y [ i - 1 ]\end{matrix} \\ 0 & otherwise ,\end{matrix} & ( 4 ) \\ {e}_{ij} = \{ \begin{matrix}max ( \begin{matrix}{ws}_{i , j} - {ws}_{i - 1 , j - 1} + \\ {e}_{i - 2 , j - 2} , {ws}_{i , j} - {ws}_{i - 2 , j - 2} + \\ {e}_{i - 3 , j - 3} , … , {ws}_{i , j} - {ws}_{i - {s}_{ij} , j - {s}_{ij}} + \\ {e}_{i - {s}_{ij} - 1 , j - {s}_{ij} - 1 , {e}_{i , j - 1} , {e}_{i - 1 , j}}\end{matrix} ) & if x [ i ] = y [ j ] \\ max ( {e}_{i - 1 , j - 1} , {e}_{i , j - 1} , {e}_{i - 1 , j} ) & otherwise\end{matrix} & ( 5 )\end{matrix}$$

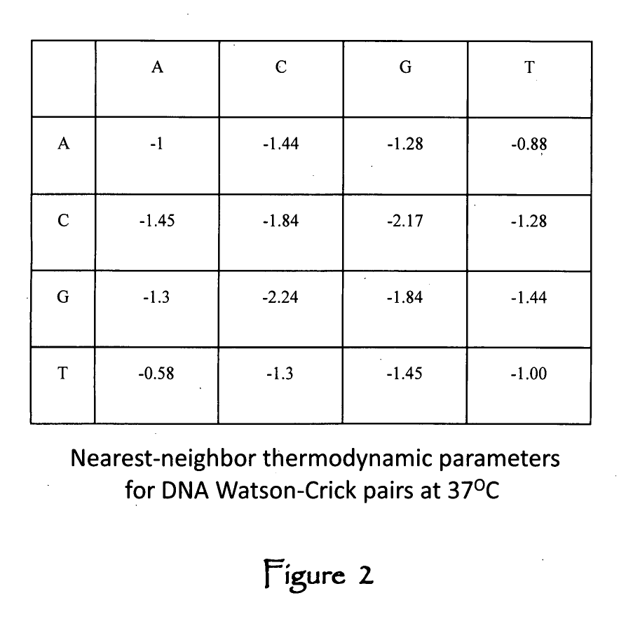

The parameter w(α[i−1],α[i]) is the stack-pair free energy specified in FIG. 2. The bottom right entry of the E matrix gives the NN free energy of

$$x : \overleftarrow{\overline{y}} .$$

Example: Consider x=5′AATGA3′ and

$$\overleftarrow{\overline{y}} = {3}^{′} CATGG {5}^{′}$$

(i.e. y=5′GTACC3′,) the matrix S, WS, and E can be calculated as the following and the NN free energy of the CH duplex is 2.33.

$$S = [ \begin{matrix}0 & 0 & 0 & 0 & 0 \\ 1 & 1 & 0 & 0 & 0 \\ 0 & 0 & 2 & 0 & 1 \\ 0 & 0 & 0 & 3 & 0 \\ 0 & 0 & 0 & 1 & 0\end{matrix} ] , \\ WS = [ \begin{matrix}0 & 0 & 0 & 0 & 0 \\ 0 & 0 & 0 & 0 & 0 \\ 0 & 0 & 0.88 & 0 & 0 \\ 0 & 0 & 0 & 2.33 & 0 \\ 0 & 0 & 0 & 0 & 0\end{matrix} ] , \\ E = [ \begin{matrix}0 & 0 & 0 & 0 & 0 \\ 0 & 0 & 0 & 0 & 0 \\ 0 & 0 & 0.88 & 0.88 & 0.88 \\ 0 & 0 & 0.88 & 2.33 & 2.33 \\ 0 & 0 & 0.88 & 2.33 & 2.33\end{matrix} ] .$$

It is important to note that the values in FIG. 2, and the values of the constraints which are used to calculate fitness may be multiplied by a constant in order to obtain values that can be represented as integers that can be stored in a digital register in hardware, e.g. the numbers might be multiplied by 100.

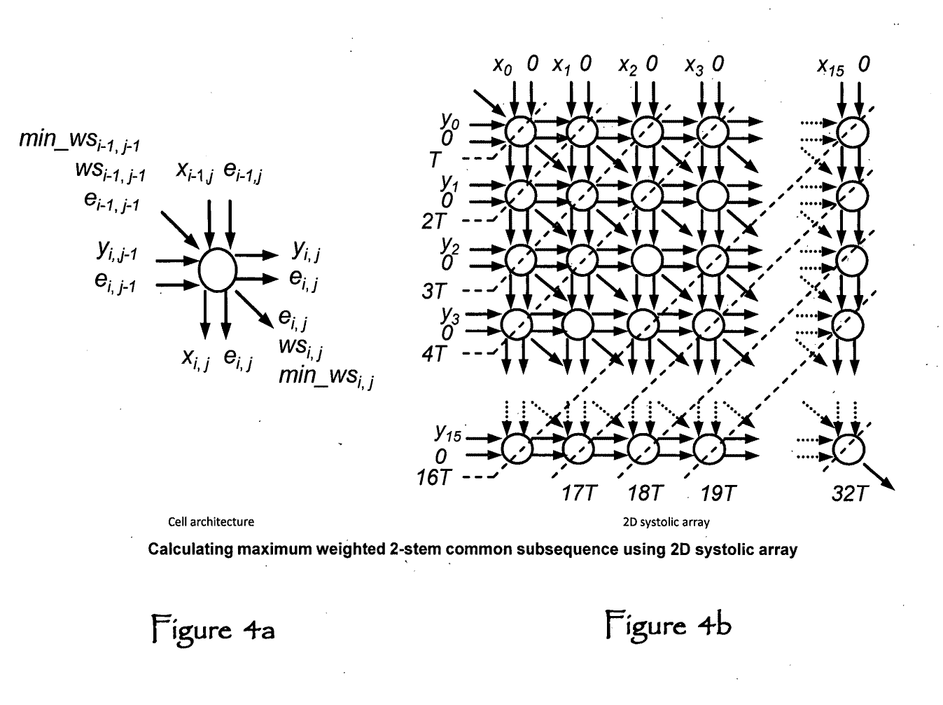

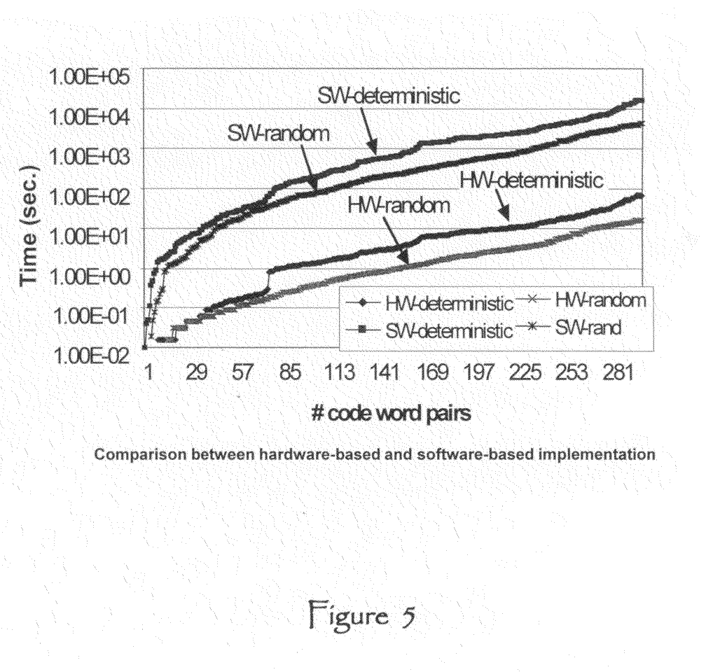

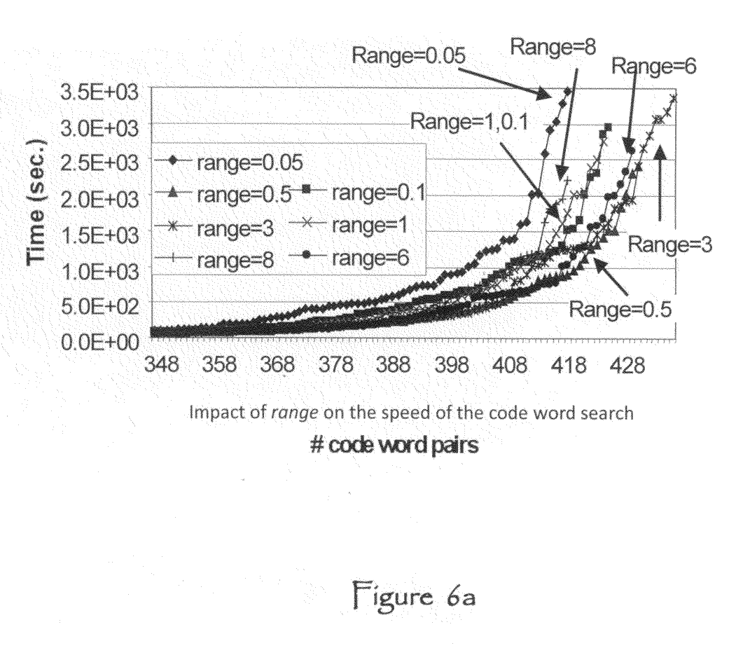

Systolic array processing has been widely used in parallel computing to enhance performance. Its general architecture is depicted in FIG. 4b. It has N×N connected processors. Each processor performs an elementary calculation. The processor P(i,j) reads data from its up stream neighbors P(i−1,j), P(i,j−1) and P(i−1, j−1), and propagates the results to its down stream neighbors P(i+1,j), P(i,j+1) and P(i+1, j+1). After an initialization period that is needed to fill the pipeline, a systolic array generates one result per 2 clock periods, or in some designs even one result per clock period.

Equations (3)-(5) cannot be directly mapped to a 2D systolic array architecture because to calculate eᵢⱼ we need the value of ws_{i-d,j-d}(e_{i-d,j-d}), 1≦d≦sᵢⱼ. The variable eᵢⱼ is calculated by processor P(i,j). The variables ws_{i-d,j-d} and e_{i-d,j-d} are calculated by processor P(i−d,j−d). If the calculation of eᵢⱼ is performed at clock period t, then the calculations of ws_{i-d,j-d} and e_{i-d,j-d} of the same DNA duplex are performed at clock period t−2d. Because cells in the systolic array will register the new input and update their results every 2 clock periods, it is not possible for us to access the data of ws_{i-d,j-d} and e_{i-d,j-d} at clock period t if d is greater than 1. One way to handle this problem is to memorize the values of ws_{i-d,j-d} and e_{i-d,j-d} by adding extra storage elements. Because the maximum value of sᵢⱼ can be as high as the length of the DNA strand, which in our case is 16 (for 16 mers, or 32 for 32 mers, etc.), this solution potentially would require duplicatation of each cell in the systolic array 16 times. This is not practical as it significantly increases the hardware cost.

In the present invention, function transformation is used to simplify the hardware design. We define a minimum weighted suffix matrix (MIN_WS) which stores the minimum value of the difference between ws_{i-d,j-d} and e_{i-d-1, j-d-1}, where 1≦d≦sᵢⱼ. The ijth entry of MIN_WS can be calculated as

$${min\_ ws}_{ij} = \{ \begin{matrix}min ( {min\_ ws}_{i - 1 , j - 1} , {ws}_{ij} - {e}_{i - 1 , j - 1} ) & if x [ i ] = y [ j ] \\ 1 , 000 , 000 & otherwise ,\end{matrix} \qquad ( 6 )$$

when x[i]≠y[j], min_wsᵢⱼ will be set to an extremely large number (for example 1,000,000 or some other large number that can be represented in the computing platform), otherwise, it is the minimum between min_ws_{i-1,j-1} and wsᵢⱼ−e_{i-1,j-1}. The calculation of eᵢⱼ and wsᵢⱼ is transformed into the following equations.

$$\begin{matrix}{ws}_{i , j} = \{ \begin{matrix}{ws}_{i - 1 , j - 1} + w ( x [ i - 1 ] , x [ i ] ) & \begin{matrix}if x [ i ] = y [ j ] \& \\ {min\_ws}_{ij} \neq 1 , 000 , 000\end{matrix} \\ 0 & otherwise\end{matrix} & ( 7 ) \\ {e}_{ij} = \{ \begin{matrix}max ( \begin{matrix}{ws}_{i , j} - {min\_ws}_{i , 1 , j - 1} , \\ {e}_{i , j - 1} , {e}_{i - 1 , j}\end{matrix} ) & if x [ i ] = y [ j ] \\ max ( {e}_{i - 1 , j - 1} , {e}_{i , j - 1} , {e}_{i - 1 , j} ) & otherwise .\end{matrix} & ( 8 )\end{matrix}$$

Equations (6)˜(8) are equivalent to equations (3)˜(5), however, only information from adjacent cells is needed in the calculation, hence, they can be implemented using the systolic array architecture.

The hardware design of the 2D systolic array can be derived directly from equations (6)˜(8). The systolic array is an n×n array of identical cells. Each cell in the array has 7 inputs, among which the inputs e_{i-1,j} and x[i−1,j] are coming from the cell that is located above, the inputs e_{i,j-1} and y[i,j−1] are coming from the cell that is located to the left, and the inputs e_{i-1,j-1}, ws_{i-1,j-1} and min_ws_{i-1,j-1} are coming from the cell that is located to the upper left. Each cell performs the computations that are described in equations (6)˜(8). For cell (i,j), the outputs x_{i,j} and y_{i,j} are equal to the inputs x_{i-1,j} and y_{i,j-1}. FIG. 4a gives the structure of each cell, including its input/output and the computation implemented. The variable x_{i,j} and y_{i,j} are represented as 2 bit binary numbers with A=00, C=01, G=10, and T=11. The variables e_{i,j}, ws_{i,j} and min_ws_{i,j} are represented as 14 bit signed integer numbers.

The overall architecture of the 2D systolic array as well as the data dependency and timing information are shown in FIG. 4b. In order to prevent ripple through operation, the cells in the even columns and even rows, and on odd columns and odd rows are synchronous to each other and perform the computation in the same clock period (or clock edge). The rest of the cells are also synchronous to each other but perform the computation in the next clock period (or on the next clock edge). In this way, the results propagate through the array diagonally. One skilled in the art would appreciate that other parallel embodiments of such a dynamic programming algorithm are possible in which calculations are performed by a more limited number of processors, perhaps synchronously along only one diagonal rather than along all diagonals as in the present embodiment, and that these would be within the spirit and scope of the present invention.

The present invention considers each DNA codeword as a sequence of length n in which each symbol is an element of an alphabet of 4 elements. Let

$$G ( x : \overleftarrow{\overline{y}} )$$

denote the nearest neighbor free energy of duplex

$$x : \overleftarrow{\overline{y}} .$$

The invention focuses on searching for a set of DNA codeword pairs S, where S consists of a set of DNA strands of length n and their reverse complement strands e.g. {(S₁, S̅₁̅), (S₂, S̅₂̅), . . . }, where (S₁, S̅₁̅) denotes a strand and its Watson-Crick complement. The problem can be formulated as the following constrained optimization problem:

$$\begin{matrix}max \vert S \vert such that & ( 8 ) \\ g - range \leq max ( G ( {s}_{1} : \overleftarrow{{s}_{1}} ) , G ( \overline{{s}_{1}} : \overleftarrow{\overline{{s}_{1}}} ) ) \leq g , & ( 9 ) \\ g - range \leq {max}_{{s}_{2} ∈ S , {s}_{2} \neq {s}_{1}} ( \begin{matrix}G ( {s}_{1} : \overleftarrow{{s}_{2}} ) , G ( {s}_{1} : \overleftarrow{\overline{{s}_{2}}} ) , \\ G ( \overline{{s}_{1}} : \overleftarrow{{g}_{2}} ) , G ( \overline{{s}_{1}} : \overleftarrow{\overline{{s}_{2}}} )\end{matrix} ) \leq g & ( 10 )\end{matrix}$$

where g and range are user defined threshold called CH upper bound and CH range. Equation (8) indicates that our objective is to maximize the size of the DNA codeword library. Constraints (9)˜(10) specify that the NN free energy of any CH duplexes must be lower than or equal to g but greater than or equal to g-range. For any DNA duplex, the weakest stacked pair is the AT pair with ΔG^{O}_{37,stack}(AT)=0.88 and ΔG^{O}_{37,stack}(TA)=0.58. Therefore, for y, x<[A,C,G,T]¹⁶, min(∥x⁽²⁾∥_{Ω},∥y⁽²⁾∥_{Ω})=7*(0.58+0.88)+0.58=10.8. Based on definition 2, the weighted t-stem distance between x and y is greater than 10.8−g and less than

$$10.8 - g + range if g - range \leq {ψ}_{Ω}^{2} ( x , y ) = G ( x : \overleftarrow{\overline{y}} ) \leq g .$$

Therefore, constraints (9)˜(10) ensure that the t-stem distance between any non-WC pairs in the library is within the range [10.8−g+range, 10.8−g]. The range was initially introduced because we thought that adding code words that are too far away from the rest of the library will restrict the future growth of the library. Therefore, we only add code words that are “just good enough”. Later in the experiments we found that the range has little impact on the size of the library, however, it has a significant impact on the convergence speed of the GA. Other sets of constraints can be used within the spirit and scope of the present invention, for example, constraints based upon different minimums, maximums, and ranges (that might even be specified separately for intended (WC) and unintended (CH) binding), desired melting temperatures, GC content, freedom from hairpins, and other constraints used by those skilled in the art of DNA Codeword library design.

The present invention solves the longstanding optimization problem involved in assembling a large set of DNA codeword pairs by using a genetic algorithm. A genetic algorithm (GA) is a stochastic search technique based on the mechanism of natural selection and recombination. Solutions, which are also called individuals, are evolved from generation to generation, with selection, mating, and mutation operators that provide an effective combination of exploration of the global search space.

Given a codeword library S, the fitness of each individual d reflects how well the corresponding codeword fits into the current codeword library. Two values define the fitness, reject_num and max_match. The reject_num is the number of codewords in the library which do not satisfy the condition (9)˜(10) and

$$max\_match = {max}_{{s}_{2} ∈ S , {s}_{2} \neq {s}_{1}} ( G ( {s}_{1} : \overleftarrow{{s}_{2}} ) , G ( {s}_{1} : \overleftarrow{\overline{{s}_{2}}} ) , G ( \overline{{s}_{1}} : \overleftarrow{{s}_{2}} ) , G ( \overline{{s}_{1}} : \overleftarrow{\overline{{s}_{2}}} ) ) .$$

The max_match is the largest violation of any of the constraints for individual d that is measured across all possible crosshybridizations in the library. Typically a code is built by repeatedly picking a first codeword candidate with random contents, and checking the constraint in (9), until one is found that passes. Then, a population of random candidate next codewords is set up. The candidates in the GA population are checked with constraints (9)-(10). Any good codewords satisfying all constraints are added to the library, the best failing codewords are identified (by storing a number that is a weighted sum of, reject_num and max_match), The GA operators are applied to produce a mixture of old and new candidates, and the steps after the initial setup are iterated. Some new candidates are constructed from old individuals in the population, and some new random individuals are added. The present invention stops after a time limit, or generation limit, or a desired library size is attained. Note that seeding the random number generator (that is used to set up the initial GA population, control the GA operators, and add new individuals) with different random number seeds causes a different first individual, different GA population candidates, and results in different DNA libraries. Thus, the algorithm can be re-run many times to produce many different libraries that each satisfy the same set of constraints.

A traditional GA mutation function might randomly pick an individual in the population, randomly pick a pair of bits in the individual representing one of its 16 bases, and randomly change the base to one of the 3 other bases in the set of 4 possible bases. In the proposed algorithm, however, an individual is randomly selected, but then exhaustively checked for all of the 48 possible base changes (for 16 mers, 3 in each of 16 base positions). This is an attempt to speed beneficial evolution of the population by minimizing the overhead that would be associated with randomly picking this individual again and again in order to test those mutations. We also specify that if none of the 48 mutations are beneficial, optionally a random individual is generated to replace the original one, or one of the mutated individuals is used to replace the original anyway. For more details about the genetic algorithm and its hardware implementation, please refer to [9]. In the present embodiment, the architecture of the hardware GA presented in [9] is extended to incorporate consideration of nearest-neighbor free energy. The 2D systolic array is used as a fitness evaluation module and the main state machine controller of the GA is modified so that it checks all the constraints (9)˜(10). In the present embodiment a hardware GA, hardware code library building loop, and hardware fitness evaluation are employed, although other embodiments within the spirit and scope of the present invention are possible that use any or all of a software GA, a software DNA library word building loop, or a software fitness evaluator.

### Experimental Results

The present invention has been tested and experimental results have been generated. A hardware accelerator that uses a stochastic GA to build DNA codeword libraries of codeword length 16 has also been designed, implemented, and tested. The invention was implemented on a reconfigurable computing platform that comprises a desktop computer and an Annapolis WildStar-Pro FPGA board. The FPGA board is plugged into the PCI-X slot of the host system. The WildStar-Pro uses XC2VP70 FPGA that has 74,448 programmable logic cells. The hardware accelerator uses about 80% of the logic resource, and it runs at 45 MHz clock frequency. A hardware based code extender that uses exhaustive search to complete the codeword library generated initially by running the GA for a limited time has also been designed and implemented. All the code word libraries that have been found were verified using the online tool SynDCode [13]. Since GA is a stochastic algorithm, all results reported are the average of multiple runs.

The first set of experiments compares the performance of the hardware-based and the software-only DNA codeword search. Two search algorithms are implemented. They are denoted as “deterministic search” (DS) and “randomized search” (RS). The population size was set to 16. The population of the DS was initialized using 16 sequential data from 0x000003F0 to 0x000003FF, which corresponds to DNA codeword 3′AATTTAAAAAAAAAAA′5 and 3′TTTTTAAAAAAAAAAA′5, while the population of the RS was initialized randomly. When a new codeword is found, or when none of the mutated codewords has lower fitness than the original individual, a new individual is generated to replace the original one. In the DS, a counter is used to generate the new individual. The counter is initialized to 0x000006D6. In the RS, the new individual is generated randomly. The random search is more effective than the deterministic search. However, in order to compare the speed of hardware-based implementation and software-based implementation, the two systems should perform exactly the same computation tasks. This is achievable only with a deterministic algorithm that uses the same sequence of (pseudo) random numbers to run the algorithm. All experiments were run with g=8.5 and range=1.0. They were terminated after 300 code word pairs have been found.

Referring to FIG. 5, the average time it takes to build large thermodynamic constrained DNA code word libraries using software on a single processor workstation, and using the hardware accelerator is depicted. The lower curves indicate faster speed. As indicated, the software-based deterministic search has the slowest performance (highest curve), while the hardware-based random search has the fastest performance (lowest curve). The hardware-based deterministic search provides approximately 240× speed-up compared to the software-only version while the hardware-based random search provides approximately 260× speed-up compared to the software-only version. Compared to the deterministic search, random search provides approximately 3.7× and 4× speed-ups using software-only and hardware-based implementations, respectively. The plot also shows that the curves for software-only implementation and hardware-based implementation are almost parallel to each other, which indicates that they both have the same complexity. Therefore, the performance gain that has been achieved by using hardware acceleration is a constant ratio. It should be noted that the performance gain obtained by moving from software to hardware, as provided by the present invention, is significantly more than that obtained by moving from deterministic to random, which highlights a significant advantage of using the present invention.

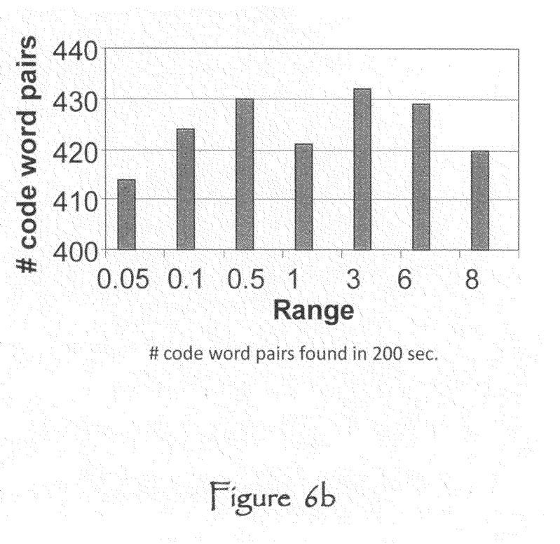

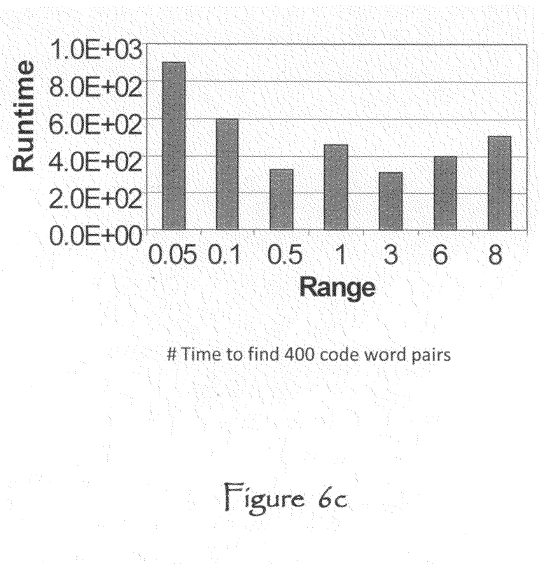

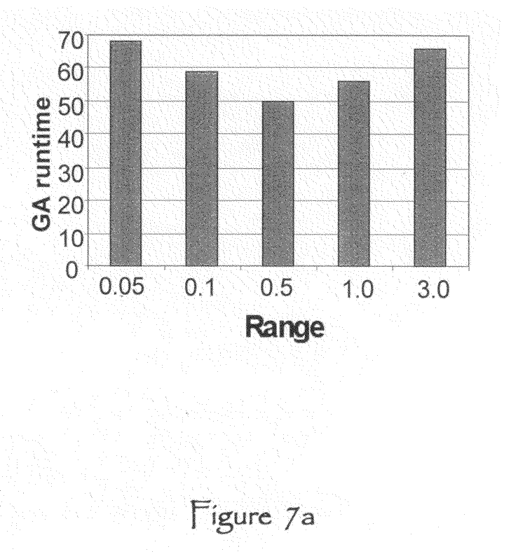

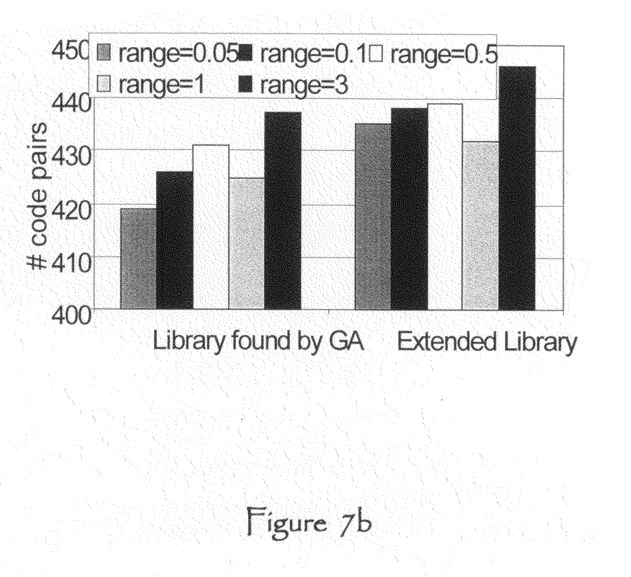

The second set of experiments evaluated the impact of CH range on the speed and quality (library size vs time) of the search. The CH range was varied from 0.05 to 3 and the GA based code word search was run with g=8.5. FIG. 6a shows library size vs time for different CH ranges. FIG. 6b and FIG. 6c give the number of code word pairs found in 200 seconds for different CH ranges, and the time required to find 400 code word pairs for different CH ranges, respectively. The results show that the library growth is slower when the CH range is either too large or too small. In the next experiment, we ran the GA until it could not find any new code words for 10 minutes, then we use exhaustive search to complete the codeword library. FIG. 7a shows the runtime of GA for different CH ranges and FIG. 7b shows the size of the library found by GA and the size of the final library for different CH ranges. Referring to FIG. 7a, the GA converges faster (gets to the point where most of the words that can be found have been found, and adding another word takes longer than 10 minutes) when setting the range to appropriate value. Compared to range=0.5, the runtime of GA is 26% and 24% longer at range=0.05 and 3.0 respectively. Referring to FIG. 7b, contrary to what was expected, the value of the CH range does not have significant impact on the final library size. The sizes of libraries found by the GA phase with different CH ranges differ by only about 4% and the final sizes of libraries extended by exhaustive search differed by only about 3%. Since the GA phase took about a minute, and the exhaustive search phase usually took about 2 hours, these results highlight an advantage of using a relatively short and highly effective GA phase to compose the initial library, and the fact that the GA phase alone discovers most of the codewords that can be found. It should be noted that these experimental results have only recently been enabled by use of the present invention to efficiently perform such experiments.

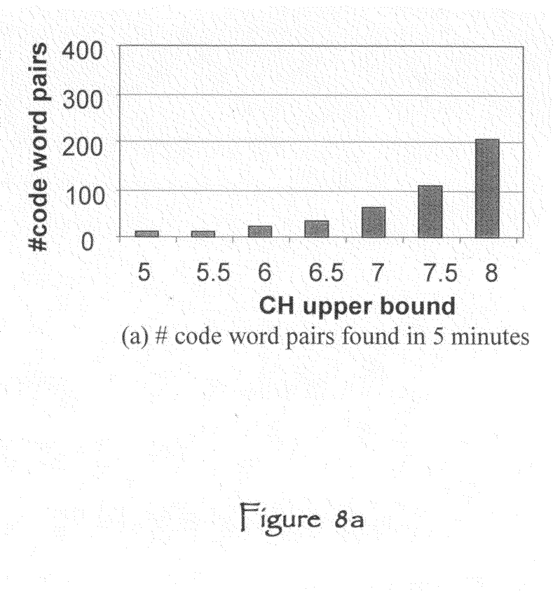

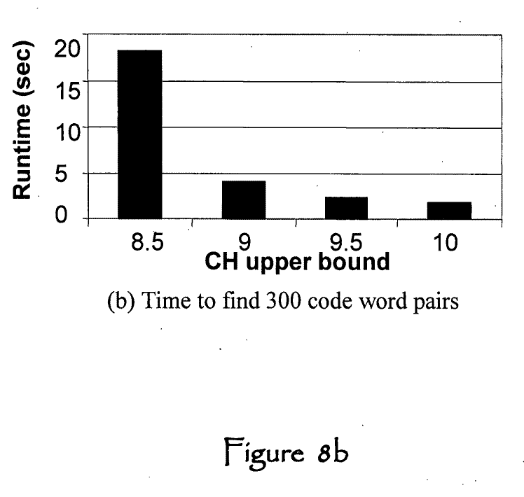

The third set of experiments compares the search speed for different CH upper bounds (g). The CH upper bound was varied from 6.5 to 10.0 and run the GA-based code word search. The search was stopped when it found 300 code word pairs or the run time exceeded 15 minutes. FIG. 8a shows the number of code word pairs found in 5 minutes for CH upper bounds from 5 to 8.0 while FIG. 8b shows the runtime to find 300 code word pairs for CH upper bound from 8.5 to 10. The results indicate that as the CH upper bound increases, the chance of finding code words increases exponentially. In general, all of these experimental results are consistent with the fact that the distribution

1. An apparatus for accelerating the production of a library of DNA codeword libraries based on nearest-neighbor free energy estimates, comprising:
a computer;
a hardware accelerator; and
a software program stored on a computer-readable medium;
wherein said software program comprises computer-executable instructions that, when said computer-readable medium is read by said computer, said instructions are executed by said computer, so as to cause said computer to communicate with said hardware accelerator so as to:
determine said free energy estimates; and
act upon a DNA codeword population so as to produce said library of DNA codewords.

2. Apparatus of claim 1, wherein said software program that comprises computer-executable instructions to determine said free energy estimates, further comprises:
computer-executable instructions that determine the maximum weighted 2-stem common subsequence of a crosshybridized duplex DNA sequence.

3. Apparatus of claim 2 wherein said computer-executable instructions that determine said maximum weighted 2-stem common subsequence are dynamically-programmable computer-executable instructions.

4. Apparatus of claim 3 wherein said dynamically-programmable computer-executable instructions are executed in a two-dimensional systolic array.

5. Said two-dimensional systolic array of claim 4, further comprising an n×n plurality of cells.

6. Said each of said n×n plurality of cells of claim 5 further comprises seven inputs, wherein,
two of said inputs originate from a cell located directly above;
two of said inputs originate from a cell directly to the left; and
three of said inputs originate from a cell directly to the upper left.

7. Said each of said n×n plurality of cells of claim 5 further comprises seven outputs, wherein,
two of said outputs terminate at a cell located directly below;
two of said outputs terminate at a cell directly to the right; and
three of said outputs terminate at a cell directly to the lower right.

8. Said each of said n×n plurality of cells of claim 5 further comprises means to produce a minimum weighted suffix matrix min_ws_{i,j}; where
$${min\_ ws}_{ij} = \{ \begin{matrix}min ( {min\_ ws}_{i - 1 , j - 1} , {ws}_{ij} - {e}_{i - 1 , j - 1} ) & if x [ i ] = y [ j ] \\ 1 , 000 , 000 & otherwise ;\end{matrix} \\ {ws}_{i , j} = \{ \begin{matrix}{ws}_{i - 1 , j - 1} + w ( x [ i - 1 ] , x [ i ] ) & \begin{matrix}if x [ i ] = y [ j ] \& \\ {min\_ws}_{ij} \neq 1 , 000 , 000\end{matrix} \\ 0 & otherwise ;\end{matrix} \\ and \\ {e}_{ij} = \{ \begin{matrix}max ( \begin{matrix}{ws}_{i , j} - {min\_ws}_{i , 1 , j - 1} , \\ {e}_{i , j - 1} , {e}_{i - 1 , j}\end{matrix} ) & if x [ i ] = y [ j ] \\ max ( {e}_{i - 1 , j - 1} , {e}_{i , j - 1} , {e}_{i - 1 , j} ) & otherwise .\end{matrix}$$

9. Said inputs and said outputs of said each of said n×n plurality of cells of claims 6 and 7, wherein for cell (i,j), the outputs x_{i,j} and y_{i,j} are equal to the inputs xᵢ₋ⱼ and y_{i,j-1.}

10. Said outputs x_{i,j} and y_{i,j} of claim 9 being 2-bit binary numbers representing DNA molecule bases according to A=00, C=01, G=10 and T=11.

11. Said variables e_{i,j}, ws_{i,j} and min_ws_{i,j} of claim 8 being represented as 14 bit signed integer numbers.

12. Said n×n plurality of cells of claim 5, wherein cells in even columns and even rows
are synchronous to each other; and
perform operations in the same clock period.

13. Said n×n plurality of cells of claim 5, wherein cells in odd columns and odd rows
are synchronous to each other; and
perform operations in successive clock periods so as to cause the results of said
operations to propagate diagonally through said two-dimensional systolic array.

14. Said computer-executable instructions of claim 1 which, when executed, cause said computer to communicate with said hardware accelerator so as to act upon a population of candidate DNA codewords so as to produce said library of DNA codewords, further comprise computer-executable instructions which, when executed:
maximize the size of said library of DNA codewords by determining the fitness of said candidate DNA codewords when checked against DNA codewords in the library;
wherein said fitness determination further comprises computer-implementable instructions which, when executed:
determining whether constraints on the estimate of free energy of binding between said candidate DNA codewords and said library of DNA codewords are met; and
quantifying the degree to which constraints on the estimate of free energy of binding between said candidate DNA codewords and said library of DNA codewords are met.

15. Said computer-executable instructions of claim 14 further comprising computer executable-instructions which, when executed, cause
the random selection of an individual said candidate DNA codeword from said population of candidate DNA codewords;
the exhaustive checking of the fitnesses of modified candidate DNA codewords formed by applying each one of all possible base changes of said randomly selected individual DNA codeword; and
specifying that when none of said modified candidate DNA codewords have a fitness that is better than original said candidate DNA codeword, said computer implementable instructions, when executed, will cause to occur one of the actions consisting of:
the random selection of a replacement individual candidate DNA codeword; and
the selection of one of said modified candidate DNA codewords.

16. Said computer-executable instructions of claim 15 further comprising computer executable-instructions which, when executed, will cause to occur one of the actions consisting of:
the selection from said candidate population said candidate DNA codewords that meet the desired constraints on the free energies of binding, and their addition to said library; and
the selection from said candidate population said candidate DNA codewords that have fitness values that meet a chosen threshold or value, and their addition to said library.

17. Said computer-executable instructions of claim 15 further comprising computer executable-instructions which, when executed, cause:
the selection and mating between best individuals in said population of candidate DNA codewords;
wherein said selection is based on a probability determined as a function of the rank or fitnesses values of said candidate codewords; and
wherein said mating is be based on a method such as selecting a single cut point location along two parent candidate DNA codewords;
said mating further producing children by concatenating the combinations of a ‘head1’ and ‘tail2’ and of a ‘head2’ and ‘tail1’; and
said mating further determining the fitness of said children, and replacing a parent by a child if the fitness is better; and
the periodic modification of said population by retaining a chosen number of said parents in said population;
the repeated adding of additional individuals with said children derived from parents that were kept until the population size reaches the original size; and
the determination of said fitness of said newly added individuals in said population.

18. Said computer-executable instructions of claim 15 further comprising computer executable-instructions which, when executed, cause a decloning step that removes said candidate DNA codewords in said population that:
are identical to any library DNA codeword, or
contain a half-strand oligomer that is identical to a half-strand oligomer present in any other candidate DNA strand in said population.

19. Said computer-executable instructions of claim 15 further comprising computer executable-instructions which, when executed, cause the determination of said fitness for each said candidate DNA codewords in said population;
wherein said determination of said fitness further comprises:
checking against all said DNA codewords in said library of selected DNA codewords; wherein
said fitness of each said candidate DNA codeword is a weighted sum of a max_match term and a rej_num term; and
said max_match term is a measure of the worst case violation of said constraints:
$$max\_match = {max}_{{s}_{2} ∈ S , {s}_{2} \neq {s}_{1}} ( G ( {s}_{1} : \overleftarrow{{s}_{2}} ) , G ( {s}_{1} : \overleftarrow{\overline{{s}_{2}}} ) , G ( \overline{{s}_{1}} : \overleftarrow{{s}_{2}} ) , G ( \overline{{s}_{1}} : \overleftarrow{\overline{{s}_{2}}} ) )$$
where
$$G ( x : \overleftarrow{\overline{y}} )$$
denote the nearest neighbor free energy of a duplex
$$x : \overleftarrow{\overline{y}} ;$$
where (s₁, S̅₁̅), (S₂, S̅₂̅), . . . denote the reverse compliment strands of a set of DNA codeword pairs S of length n;
where (S₁, S̅₁̅) denotes a strand and its Watson-Crick complement;
where said rej_num denotes a measure of the number of DNA codewords in the library for which said constraints are not met; and
where said constraints limit the range of the intended and unintended free energy of binding between the half-strand oligomers present in said DNA codewords in said library.

20. Said computer-executable instructions of claim 16 further comprising computer executable-instructions which, when executed, determine whether the free energy of binding estimates based on the weighted t-stem distance between x and y and the nearest neighbor model of any said duplex
$$\overline{x : y} - x : y$$
is within the range:
10.8−g to 10.8−g+range
where x is a half-strand oligomer present in a chosen candidate DNA codeword; and
where y is a half-strand oligomer present in a library DNA codeword or its reverse complement; and
where g is a user-defined crosshybridization free energy upper bound; and
where range is a user-defined crosshybridization free energy range.
